(19) United States
(12) Patent Application Publication
(10) Pub. No.: US 2026/0037406 A1
(43) Pub. Date: Feb. 5, 2026

(54) Automated Configuration Of Monitoring System From Rule Based Machine Learning Explainability Techniques

(71) Applicant: Oracle International Corporation, Redwood Shores, CA (US)

(72) Inventors: Louis Faucon, Zurich (CH); Arnaud Delamare, Zurich (CH); Alexander Weld, Zurich (CH); Ljupche Milosheski, Zurich (CH); Sungpack Hong, Palo Alto, CA (US)

(21) Appl. No.: 18/791,142

(22) Filed: Jul. 31, 2024

(51) Int. Cl. G06F 11/34; G06F 11/30; G06N 3/045; G06N 3/088

(52) U.S. Cl. CPC G06F 11/3447; G06F 11/3006; G06N 3/045; G06N 3/088

(57) ABSTRACT

An automated monitoring system configuration uses a combination of an anomaly detection model and a rule-based explainability model for automating configuration of a monitoring system. A set of alarm rule suggestions is generated based on a set of time series signals by applying an unsupervised anomaly detection model to generate a set of labeled anomalies and applying a rule-based explainability model to generate alarm rules from the set of labeled anomalies. The monitoring system may be automatically configured with the set of alarm rule suggestions. Alternatively, the set of alarm rule suggestions may be presented to a user with controls for selecting or unselecting alarm rules. The automated configuration may determine a rule for each signal having a detected anomaly based on the selected rule providing the most increased coverage of the set of labeled anomalies. The automated configuration continues to add selected rules until a coverage threshold is reached.

### FIELD OF THE INVENTION

The present invention relates to configuration of monitoring systems for cloud applications and, more specifically, to automated configuration of monitoring systems from rule-based machine learning explainability techniques.

### BACKGROUND

A cloud platform or cloud environment provides servers, storage, network, applications, and services through a network of managed data centers. A cloud platform provides Infrastructure as a Service (IaaS), Platform as a Service (PaaS), Software as a Service (SaaS), and Data as a Service (DaaS) infrastructure that can be used to build, deploy, integrate, and extend applications in the cloud.

A cloud monitoring system monitors performance and health metrics to allow monitoring of key components in the cloud environment, such as applications, servers, databases, and back-end components. Any cloud application requires a monitoring system to alert on-call engineers when an incident occurs. Configuring such monitoring systems takes time and effort from expert software development and Information Technology operations (DevOps) engineers. Thus, a need exists to automate the process of configuring monitoring systems.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 is a block diagram illustrating cloud application monitoring in accordance with an embodiment.

FIG. 2 illustrates alarm rule suggestion generation for a cloud application in accordance with an embodiment.

FIG. 3 is a block diagram illustrating alarm rule suggestion generation using machine learning techniques in accordance with an embodiment.

FIG. 4 depicts an example table of time series signal data from which alarm suggestions can be generated in accordance with an embodiment.

FIG. 5 depicts an example table of labeled time series signal data from which alarm suggestions can be generated in accordance with an embodiment.

FIG. 6 illustrates an example of a rule for a particular time series signal in accordance with an embodiment.

FIG. 7 depicts an example table of rules explaining anomalies from which alarm suggestions can be generated in accordance with an embodiment.

FIG. 8 is a flowchart illustrating operation of a system for automatic generation of alarm rule suggestions and configuration of a monitoring system in accordance with an embodiment.

FIG. 9 is a flowchart illustrating operation of a system for generating alarm rule suggestions using a coverage based explainability model in accordance with an embodiment.

FIG. 10 is a block diagram that illustrates a computer system upon which aspects of the illustrative embodiments may be implemented.

FIG. 11 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Monitoring systems must be configured with alarm rules that determine when an incident is detected and whether a notification must be generated. In monitoring systems of cloud platforms, this configuration must be done by DevOps engineers, using either a graphical user interface or with code. The illustrative embodiments herein use a combination of an anomaly detection model and a rule-based machine language (ML) explainability model for automating configuration of a monitoring system. In accordance with the illustrative embodiments, a set of alarm rule suggestions is generated based on a set of time series signals by applying an unsupervised anomaly detection model to generate a set of labeled anomalies and applying a rule-based ML explainability model to generate alarm rules from the set of labeled anomalies. In one embodiment, the monitoring system is automatically configured with the set of alarm rule suggestions. In another embodiment, the set of alarm rule suggestions are presented to a user with selectable controls for selecting or unselecting alarm rules within the set of alarm rule suggestions. The user interface enables the user to select a subset of the set of alarm rule suggestions for configuring the monitoring system. In one embodiment, the user interface enables the user to adjust the suggested rules, such as by adjusting thresholds, for example.

In some embodiments, the automated configuration determines a rule for each signal having a detected anomaly based on the selected rule providing the most increased coverage of the set of labeled anomalies. The automated configuration adds the selected rule to the set of alarm rule suggestions. In one embodiment, the automated configuration continues to add selected rules until a coverage threshold is reached.

Manually configuring monitoring systems of large-scale cloud applications can take months of engineering effort. Automating the process increases productivity for engineering teams. Furthermore, automated configurations can lead to monitoring systems with more complete coverage of anomalous behavior and more helpful rules. The illustrative embodiments enable high quality automation of the process of generating rules. In addition, the automation is performed in an unsupervised manner; therefore, no manual labeling is required. Given the nature of ML explainability techniques, the automated configuration is easily understandable and transparent for users.

The automated configuration process of the illustrative embodiments requires historical data, which means that in some implementations, the cloud application may run for multiple days without a monitoring system to generate the historical data and enable the automatic configuration. Also, it is possible that a manual configuration by an expert DevOps engineer with time and effort may be superior to an automated configuration. However, it is also possible that the automated configuration may cover anomalous behavior that would not be identified without the historical data. Furthermore, the automated configuration can create alarm rule suggestions with desired coverage in less time than possible with manual configuration.

### Application Monitoring

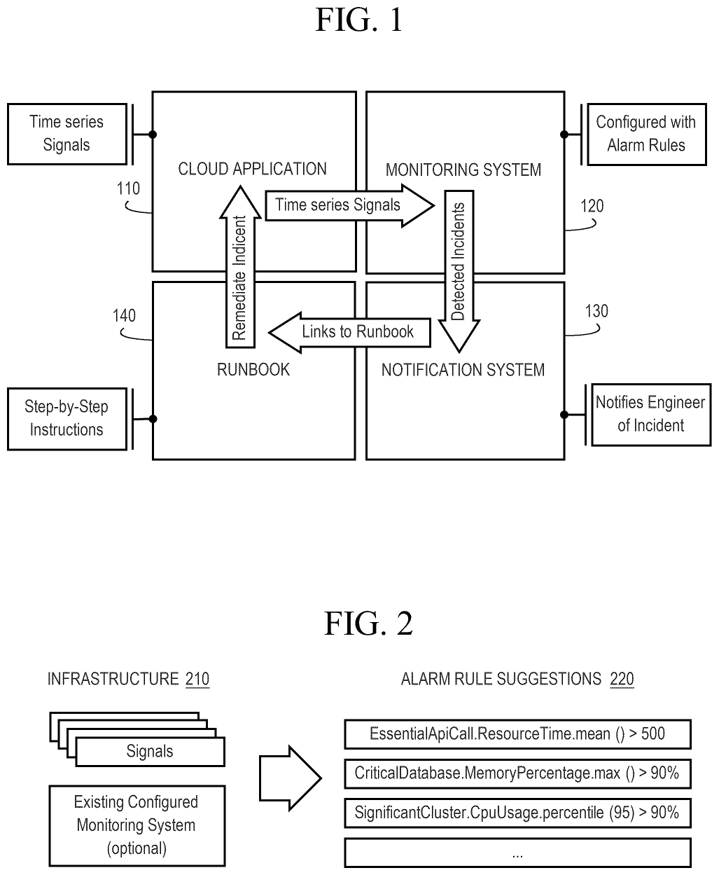

FIG. 1 is a block diagram illustrating cloud application monitoring in accordance with an embodiment. Cloud application 110 is instrumented with a monitoring agent (not shown) that generates time series signals, which are provided to monitoring system 120. An example of monitoring agent instrumentation may include the OpenTelemetry observability framework, for example, which generates time series signals referred to as “telemetry signals.” Examples of time series signals may include central processing unit (CPU) load, memory usage, failure rate, etc.

Monitoring system 120 is configured with alarm rules that are used to detect incidents that occur based on the time series signals. Monitoring system 120 communicates detected incidents to notification system 130. In response to a detected incident, notification system 130 notifies the on-call engineer (OCE) that an incident is detected. In turn, the OCE links to runbook 140 to remediate the incident. A runbook is a set of step-by-step instructions for the OCE to investigate and remediate incidents. The step-by-step instructions may be standardized written procedures for completing repetitive IT processes within a company. The step-by-step instructions in runbook 140 are executed to remediate the incident.

### Generation of Alarm Rule Suggestions

The illustrative embodiments allow DevOps engineers to receive suggestions of alarm rules, which are the core constituent of the configuration of monitoring system 120. These suggestions can be rejected or accepted in a single click, or automatically implemented, to become an integral part of the monitoring system configuration of cloud application 110, effectively making configuration of management system 120 fully automated. FIG. 2 illustrates alarm rule suggestion generation for a cloud application in accordance with an embodiment. The embodiments provide alarm rule suggestions 220 automatically solely from the time series signals generated by infrastructure 210 or optionally referring to an already partially configured monitoring system within infrastructure 210.

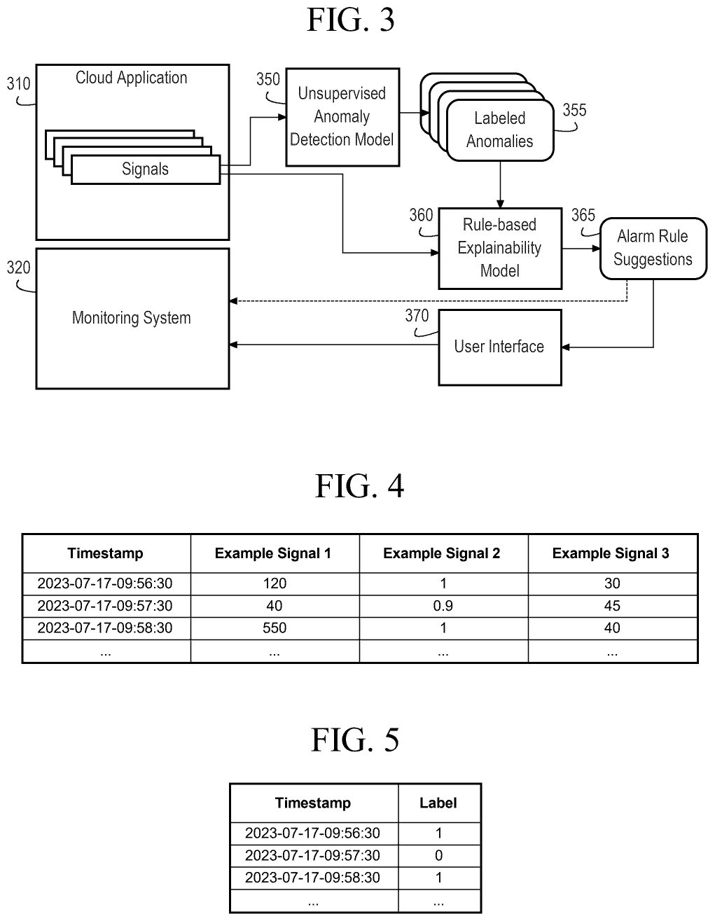

FIG. 3 is a block diagram illustrating alarm rule suggestion generation using machine learning techniques in accordance with an embodiment. The alarm rule suggestion generation of the illustrative embodiment uses a combination of multiple machine learning techniques to generate the alarm rule suggestions. Cloud application 310 includes logic, such as one or more monitoring system agents, to generate time series signals. First, an unsupervised anomaly detection model 350 receives the time series signals from cloud application 310 and detects anomalies in the time series signals to generate labeled anomalies 355.

Rule-based explainability model 360 receives the time series signals from cloud application 310 and the labeled anomalies 355 and uses machine learning (ML) explainability techniques to build rules in order to explain the anomaly labels. These rules can be modified to be used as alarm rule suggestions 365. Multiple choices of unsupervised anomaly detection models and explainability models can be used interchangeably. These choices will impact the quality of the alarm rule suggestions. Thus, the unsupervised anomaly detection model 350 and the rule-based explainability model 360 may be selected based on the cloud application 310 and the specific time series signals that are provided as inputs to the models.

In some embodiments, alarm rule suggestions 365 are presented to a user, such as a DevOps engineer, in user interface 370. In one embodiment, the user can select the alarm rule suggestions 365 in user interface 370 to be implemented in monitoring system 320. In one example embodiment, user interface 370 provides selectable controls that allow the user to select or deselect individual rules from the alarm rule suggestions 365. In an alternative embodiment, monitoring system 320 can be automatically configured with alarm rule suggestions 365. In one embodiment, user interface 370 enables the user to adjust the alarm rule suggestions 365, such as by adjusting thresholds, for example.

### Unsupervised Anomaly Detection Model

FIG. 4 depicts an example table of time series signal data from which alarm suggestions can be generated in accordance with an embodiment. The time series signal data depicted in FIG. 4 includes three example signals, each having a value at a respective timestamp. Example signal 1 represents application programming interface (API) latency in milliseconds. Example signal 2 represents workflow success rate as a value from 0 to 1. Example signal 3 represents cluster node CPU usage as a percentage.

The unsupervised detection model 350 is used to assign labels to all timestamps. These labels may be, for example, a value of 1 for anomalies and a value of 0 for timestamps with normal signals. Unsupervised detection model 350 may be implemented using code similar to the following example:

import pandas as pd
from example_ml_library import ExampleAnomalyDetectionModel
signals_df = pd.read_csv(“signals.csv”)
model = ExampleAnomalyDetectionModel
model.fit(signals_df)
labels_df = model.predict(signals_df)
labels_df.to_csv(“labels.csv”)

The above code is provided for illustrative purposes, and actual code for implementing unsupervised detection model 350 may vary depending on the programming language used, the computing environment, and other factors.

Existing anomaly detection models may be good options for unsupervised detection model 350. Some examples include Mahalanobis Distance, Multivariate State Estimation Technique (MSET), and Local Outlier Factors (LOF). Mahalanobis Distance is an effective multivariate distance metric that measures the distance between a point (vector) and a distribution. Mahalanobis Distance has applications in multivariate anomaly detection and other use cases. MSET is a nonlinear, nonparametric anomaly detection ML technique that calibrates the expected behavior of a system based on historical data from the normal operational sequence of monitored signals. MSET incorporates the learned behavior of a system into a persistent model that represents the normal estimated behavior. The LOF algorithm is an unsupervised anomaly detection method that computes the local density deviation of a given data point with respect to its neighbors. LOF considers as outliers the samples that have a substantially lower density than their neighbors. Other anomaly detection models can be used within the spirit and scope of the illustrative embodiments.

The unsupervised anomaly detection model 350 provides labeled anomalies 355 as the result. FIG. 5 depicts an example table of labeled time series signal data from which alarm suggestions can be generated in accordance with an embodiment. In the depicted example, labels are generated by assigning a value of 1 for anomalies and a value of 0 for timestamps with normal signals. Other conventions may be used within the spirit and scope of the illustrative embodiments.

### Rule-Based Explainability Model

The next step is to use a rule-based explainability model 360 to generate rules that explain the labeled anomalies 355. In this context, a rule-based explainability model refers to any automated mechanism that receives as inputs time series signal values and labels for anomalies and builds a collection of rules of the type “IF <signal> <ABOVE|BELOW> <threshold> THEN event predicted as anomaly”. These simple rules are exactly the kind of rules configured in monitoring systems. In one embodiment, modifications for syntax may be performed to conform to the monitoring system being implemented. The collection of rules generated by rule-based explainability model 360 must be such that the rules fit the labels with high recall and accuracy.

Rule-based explainability model 360 may be implemented using code similar to the following example:

import pandas as pd
from example_ml_library import ExampleRuleBasedExplainer
signals_df = pd.read_csv(“signals.csv”)
labels_df = pd.read_csv(“labels.csv”)
explainer = ExampleRuleBasedExplainer( )
rules_df = explainer.run(signals_df, labels_df)

The above code is provided for illustrative purposes, and actual code for implementing unsupervised detection model 350 may vary depending on the programming language used, the computing environment, and other factors.

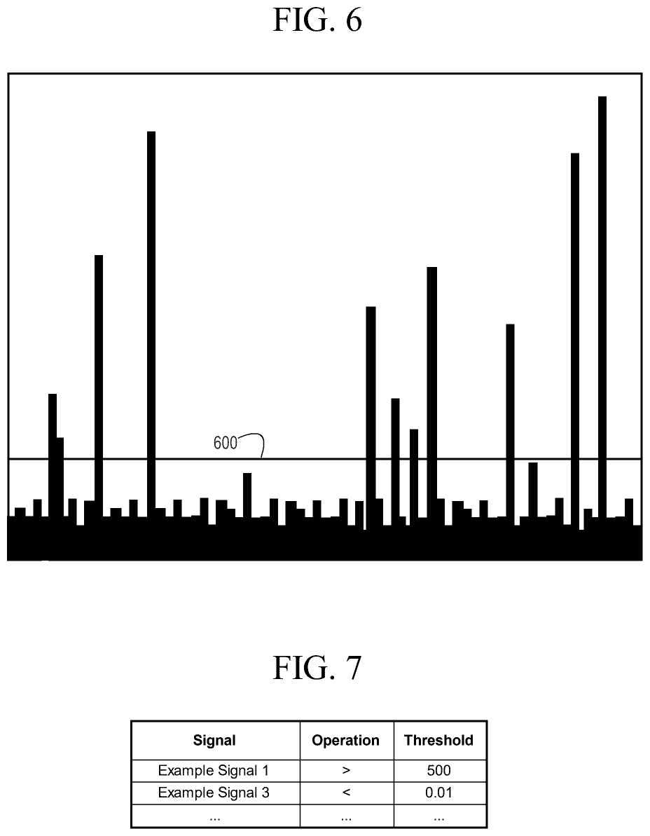

FIG. 6 illustrates an example of a rule for a particular time series signal in accordance with an embodiment. With time going from left to right, the signal values (black) are separated between two zones: anomalies (above threshold 600) and normal (below threshold 600).

The rule-based explainability model 360 generates outputs a list of rules that are operations (above/below) with a selected threshold. FIG. 7 depicts an example table of rules explaining anomalies from which alarm suggestions can be generated in accordance with an embodiment. These outputs conform with what monitoring systems require for their configuration. At this stage, the alarm rule suggestions have been automatically generated. The final step is to integrate a configuration in the monitoring system, which may involve a stage of review from a DevOps engineer or another suer or may involve automatic implementation of the alarm rule suggestions.

Some examples of explainer models include: Scalable Bayesian Rule List, Decision Trees, Random Forest, and XGBoost. Scalable Bayesian Rule Lists (SBRL) is an algorithm for building probabilistic rule lists. A decision tree is an explainable machine learning algorithm all by itself and is used widely for feature importance of linear and non-linear models. Explainable Random Forest (XRF) models are both very accurate and can be augmented with explainability functionality, allowing end-users to learn how and why a specific outcome was reached. XGBoost, short for Extreme Gradient Boosting, is an open-source machine learning library that implements optimized distributed gradient-boosted decision tree (GBDT) algorithms. XGBoost provides a simple representation of the importance of each feature in a dataset. Other explainer models can be used within the spirit and scope of the illustrative embodiments.

### Custom Implementation Based on Coverage

In one embodiment, alarm rules are selected based on coverage of labeled anomalies. For each signal, a coverage of the labeled anomalies is determined for each combination of a threshold within range of the minimum value and maximum value of the signal and each comparison condition (e.g., < or >). If a given combination of a threshold and a comparison condition results in a rule with the best coverage increase, then the rule using the given combination of threshold and comparison condition is added to the alarm rule suggestions. This process can be repeated until all signals are considered or until a predetermined coverage threshold (e.g., 99%) is achieved.

Thus, for each signal, the coverage-based explainability model considers all threshold values from the minimum value to the maximum value of the signal and considers each operation to determine how much a rule using the threshold value and the operation increases the coverage of detected anomalies. That is, the model identifies the rule for a signal that best explains detected anomalies, either for that signal or globally in the cloud application. The rule for a signal that results in a highest increase in the coverage of anomalies is added to the alarm rule suggestions.

This coverage-based explainability model may be implemented using code similar to the following example:

```
import pandas as pd
TARGET_COVERAGE_THRESHOLD = 0.99
signals_df = pd.read_csv(“signals.csv”)
labels_df = pd.read_csv(“labels.csv”)
coverage = 0
selected_rules = [ ]
while coverage < TARGET_COVERAGE_THRESHOLD:
  best_coverage_increase = 0
  best_rule = None
  for signal in signals_df.columns:
    for threshold in range(signals_df[signal].min( ),
    signals_df[signal].max( ))
      for operation in [“<”, “>”]:
        coverage_increase = compute_coverage(selected_rules,
        signals_df, labels_df, signal, threshold, operation)
        if coverage_increase > best_coverage_increase:
          best_coverage_increase = coverage_increase
          best_rule = (signal, operation, threshold)
  coverage += best_coverage_increase
  selected_rules.append(best_rule)
```

The above code is provided for illustrative purposes, and actual code for implementing coverage-based explainability model may vary depending on the programming language used, the computing environment, and other factors.

### Procedural Overview

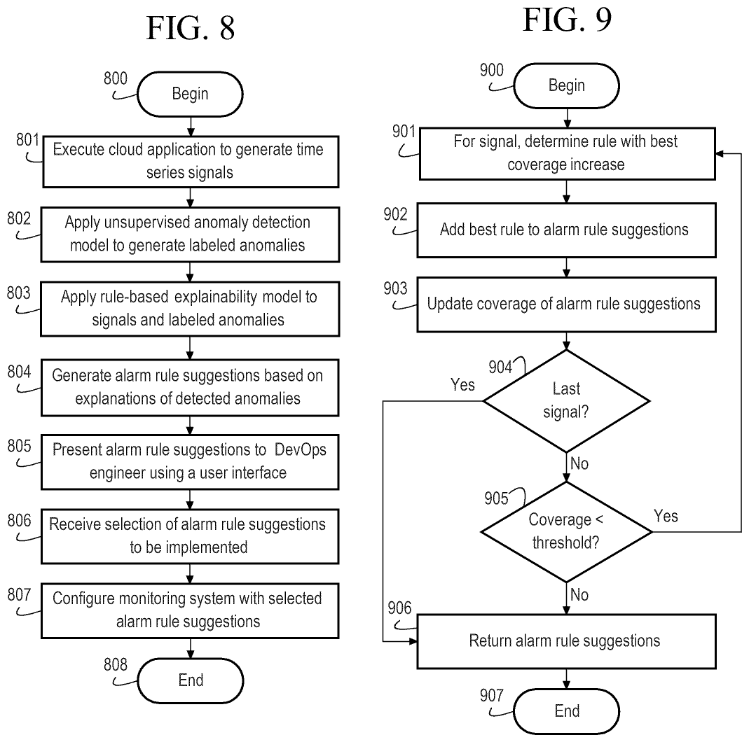

FIG. 8 is a flowchart illustrating operation of a system for automatic generation of alarm rule suggestions and configuration of a monitoring system in accordance with an embodiment. Operation begins (block 800), and the system executes the cloud application to generate time series signals (block 801). Preferably, the execution of the cloud application is for a sufficient amount of time and a sufficient workload such that anomalous behavior will be captured by the generated time series signals. In some embodiments, the execution of the cloud application will be without a monitoring system configured. Alternatively, a monitoring system may be configured with default set of alarm rules during this period of time.

The system applies an unsupervised anomaly detection model to the time series signals to generate labeled anomalies in the time series signals (block 802). Existing anomaly detection models may be used for unsupervised learning of the time series signals and anomaly detection. The result is a labeled set of time series signals where timestamps associated with anomalous signals are labeled with a first value (e.g., 1) and timestamps associated with normal operation are labeled with a second value (e.g., 0).

The system applies a rule-based explainability model to the signals and the labeled anomalies (block 803). The system generates alarm rule suggestions based on the explanations for the detected anomalies (block 804). Existing ML explainability models may be used for explaining anomalies detected in the time series signals. In one embodiment, the explainability model may be a custom explainability model based on coverage of detected anomalies, as will be described in further detail below with reference to FIG. 9.

The system presents the alarm rule suggestions to a DevOps engineer, or other user, using a user interface (block 805). In one embodiment, the user interface includes a selectable control to accept the alarm rule suggestions for implementation to configure the monitoring system. The user interface may also include a selectable control to reject the alarm rule suggestions. Alternatively, or in addition, the user interface may include an individual control for each alarm rule to allow the user to select or deselect each alarm rule. The system receives selection of the alarm rule suggestions to be implemented (block 806). The system then configures the monitoring system with the selected alarm rule suggestions (block 807). In one alternative embodiment, the system may automatically configure the monitoring system with alarm rule suggestions without input from a user. Thereafter, operation ends (block 808).

FIG. 9 is a flowchart illustrating operation of a system for generating alarm rule suggestions using a coverage based explainability model in accordance with an embodiment. Operation begins (block 900) and receives as input a set of time series signals and a labeled set of anomalies within the set of time series signals. For each signal, the system determines a rule with the best coverage increase (block 901). That is, for a given signal, the system considers a range of threshold values from the minimum value of the signal to the maximum value of the signal and considers each comparison condition (e.g., < or >). For each combination of a threshold value and a comparison condition, the system determines how much an alarm rule using the combination increases the coverage of detected anomalies. Thus, given the alarm rules selected so far and a current alarm rule for a given combination of a threshold value and a comparison condition, the system determines a coverage increase relative to the coverage of the alarm rule selected so far without the current alarm rule. For a given signal, the system selects the alarm rule having the highest coverage increase.

The system adds the best rule for the signal to the alarm rule suggestions (block 902) and updates the coverage of the alarm rule suggestions (block 903). The system determines if the current signal is the last signal (block 904). If the current signal is not the last signal (block 904:No), then the system determines whether the coverage is less than a predetermined coverage threshold (block 905). If the coverage is less than the predetermined coverage threshold (block 905:Yes), then operation returns to block 901 and repeats until either all signals have been considered (block 904:Yes) or coverage has reached the predetermined coverage threshold (block 905:No). If all signals have been considered (block 904:Yes) or coverage is not less than the predetermined coverage threshold (block 905:No), then the system returns the alarm rule suggestions (block 906), and operation ends (block 907).

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

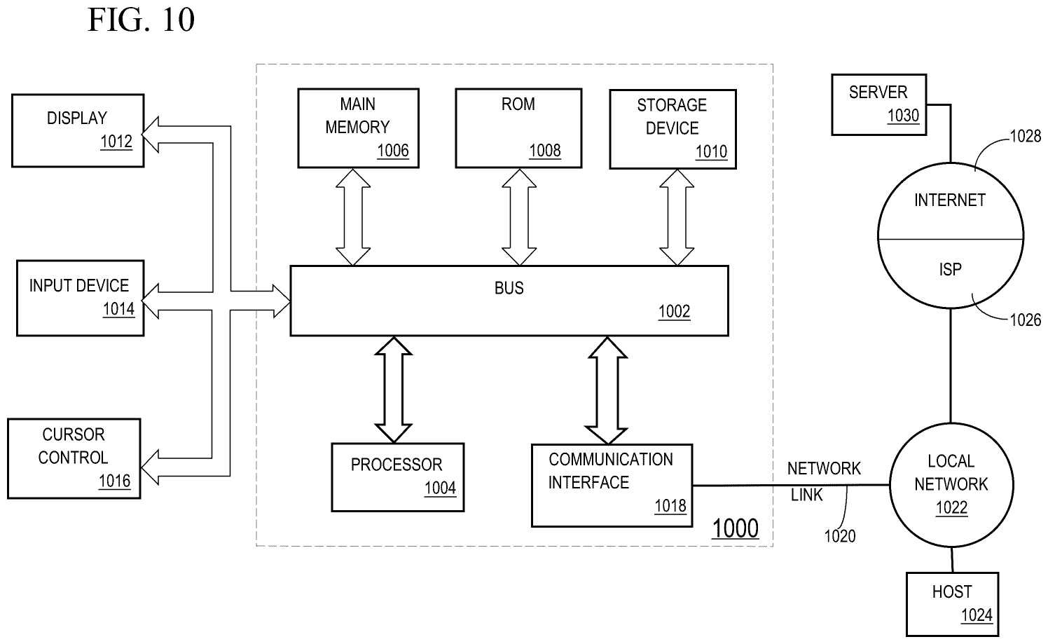

For example, FIG. 10 is a block diagram that illustrates a computer system 1000 upon which aspects of the illustrative embodiments may be implemented. Computer system 1000 includes a bus 1002 or other communication mechanism for communicating information, and a hardware processor 1004 coupled with bus 1002 for processing information. Hardware processor 1004 may be, for example, a general-purpose microprocessor.

Computer system 1000 also includes a main memory 1006, such as a random-access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic, or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world-wide packet data communication network now commonly referred to as the “Internet” 1028. Local network 1022 and Internet 1028 both use electrical, electromagnetic, or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

### Software Overview

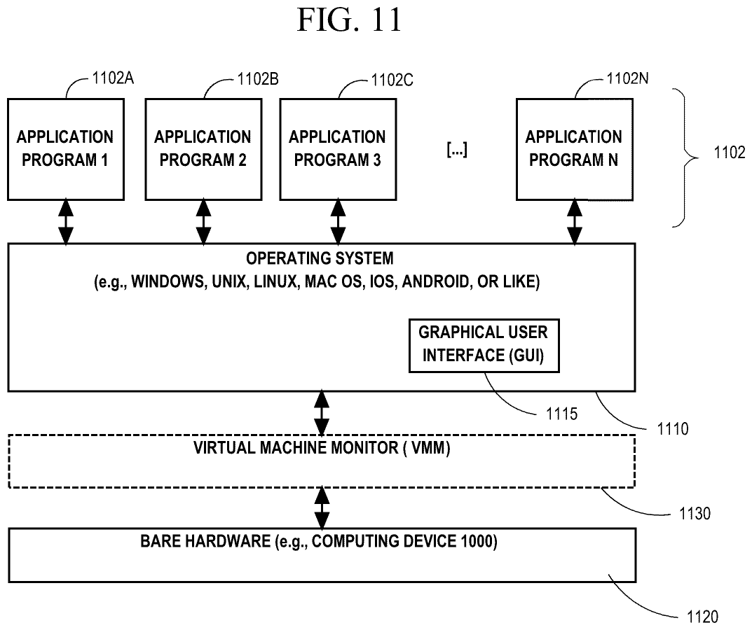

FIG. 11 is a block diagram of a basic software system 1100 that may be employed for controlling the operation of computer system 1000. Software system 1100 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1100 is provided for directing the operation of computer system 1000. Software system 1100, which may be stored in system memory (RAM) 1006 and on fixed storage (e.g., hard disk or flash memory) 1010, includes a kernel or operating system (OS) 1110.

The OS 1110 manages low-level aspects of computer operation, including managing execution of processes, memory allocation, file input and output (I/O), and device I/O. One or more application programs, represented as 1102A, 1102B, 1102C . . . 1102N, may be “loaded” (e.g., transferred from fixed storage 1010 into memory 1006) for execution by system 1100. The applications or other software intended for use on computer system 1000 may also be stored as a set of downloadable computer-executable instructions, for example, for downloading and installation from an Internet location (e.g., a Web server, an app store, or other online service).

Software system 1100 includes a graphical user interface (GUI) 1115, for receiving user commands and data in a graphical (e.g., “point-and-click” or “touch gesture”) fashion. These inputs, in turn, may be acted upon by the system 1100 in accordance with instructions from operating system 1110 and/or application(s) 1102. The GUI 1115 also serves to display the results of operation from the OS 1110 and application(s) 1102, whereupon the user may supply additional inputs or terminate the session (e.g., log off).

OS 1110 can execute directly on the bare hardware 1120 (e.g., processor(s) 1004) of computer system 1000. Alternatively, a hypervisor or virtual machine monitor (VMM) 1130 may be interposed between the bare hardware 1120 and the OS 1110. In this configuration, VMM 1130 acts as a software “cushion” or virtualization layer between the OS 1110 and the bare hardware 1120 of the computer system 1000.

VMM 1130 instantiates and runs one or more virtual machine instances (“guest machines”). Each guest machine comprises a “guest” operating system, such as OS 1110, and one or more applications, such as application(s) 1102, designed to execute on the guest operating system. The VMM 1130 presents the guest operating systems with a virtual operating platform and manages the execution of the guest operating systems.

In some instances, the VMM 1130 may allow a guest operating system to run as if it is running on the bare hardware 1120 of computer system 1000 directly. In these instances, the same version of the guest operating system configured to execute on the bare hardware 1120 directly may also execute on VMM 1130 without modification or reconfiguration. In other words, VMM 1130 may provide full hardware and CPU virtualization to a guest operating system in some instances.

In other instances, a guest operating system may be specially designed or configured to execute on VMM 1130 for efficiency. In these instances, the guest operating system is “aware” that it executes on a virtual machine monitor. In other words, VMM 1130 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
detecting one or more anomalies in a set of time series signals received from one or more applications executing in a cloud platform;
using a rule-based explainability model to generate a set of rule-based explanations for the one or more anomalies based on the set of time series signals and the one or more anomalies;
generating a set of alarm rule suggestions based on the set of rule-based explanations; and
configuring at least a subset of the set of alarm rule suggestions as alarm rules in a monitoring system of the cloud platform,
wherein the method is performed by one or more computing devices.

2. The method of claim 1, wherein detecting the one or more anomalies comprises applying an unsupervised anomaly detection model to the set of time series signals to generate one or more labeled anomalies.

3. The method of claim 2, wherein the unsupervised anomaly detection model applies a first value to a given signal at a particular timestamp if an anomaly is detected or a second value to the given signal at the particular timestamp if an anomaly is not detected.

4. The method of claim 2, wherein the unsupervised anomaly detection model comprises:
a Mahalanobis Distance model,
a Multivariate State Estimation Technique (MSET) model, or
a Local Outlier Factor (LOF) model.

5. The method of claim 1, wherein a given rule-based explanation in the set of rule-based explanations specifies a given time series signal, a threshold value, and a comparison condition.

6. The method of claim 1, wherein the rule-based explainability model comprises:
a Scalable Bayesian Rule List model,
a Decision Tree model,
a Random Forest model,
an eXtreme Gradient Boosting (XGBoost) model, or
a custom rule-based implementation.

7. The method of claim 1, wherein configuring at least a subset of the set of alarm rule suggestions comprises:
causing the set of alarm rule suggestions to be displayed to a user; and
in response to the user accepting the set of alarm rule suggestions, configuring the set of alarm rule suggestions as alarm rules in the monitoring system of the cloud platform.

8. The method of claim 1, wherein configuring at least a subset of the set of alarm rule suggestions comprises:
causing the set of alarm rule suggestions to be displayed to a user in a user interface, wherein the user interface provides, for each alarm rule suggestion, a user-selectable control for selecting the corresponding alarm rule suggestion; and
in response to the user selecting a particular alarm rule suggestion using the corresponding user-selectable control, configuring the particular alarm rule suggestion as an alarm rule in the monitoring system of the cloud platform.

9. The method of claim 1, wherein:
the rule-based explainability model comprises a coverage-based explainability model, and
using the rule-based explainability model comprises for each signal:
identifying a combination of a threshold and a comparison condition that results in a highest increase of coverage of the one or more anomalies;
generating an alarm rule based on the identified combination of the threshold and the comparison condition; and
adding the generated alarm rule to the set of alarm rule suggestions.

10. The method of claim 9, wherein using the rule-based explainability model comprises returning the set of alarm rule suggestions in response to a coverage threshold being reached.

11. One or more non-transitory computer-readable media storing instructions which, when executed by one or more processors, causes performance of:
detecting one or more anomalies in a set of time series signals received from one or more applications executing in a cloud platform;
using a rule-based explainability model to generate a set of rule-based explanations for the one or more anomalies based on the set of time series signals and the one or more anomalies;
generating a set of alarm rule suggestions based on the set of rule-based explanations; and
configuring at least a subset of the set of alarm rule suggestions as alarm rules in a monitoring system of the cloud platform.

12. The one or more non-transitory computer-readable media of claim 11, wherein detecting the one or more anomalies comprises applying an unsupervised anomaly detection model to the set of time series signals to generate one or more labeled anomalies.

13. The one or more non-transitory computer-readable media of claim 12, wherein the unsupervised anomaly detection model applies a first value to a given signal at a particular timestamp if the an anomaly is detected or a second value to the given signal at the particular timestamp if an anomaly is not detected.

14. The one or more non-transitory computer-readable media of claim 12, wherein the unsupervised anomaly detection model comprises:
a Mahalanobis Distance model,
a Multivariate State Estimation Technique (MSET) model, or
a Local Outlier Factor (LOF) model.

15. The one or more non-transitory computer-readable media of claim 11, wherein a given rule-based explanation in the set of rule-based explanations specifies a given time series signal, a threshold value, and a comparison condition.

16. The one or more non-transitory computer-readable media of claim 11, wherein the rule-based explainability model comprises:
a Scalable Bayesian Rule List model,
a Decision Tree model,
a Random Forest model,
an eXtreme Gradient Boosting (XGBoost) model, or
a custom rule-based implementation.

17. The one or more non-transitory computer-readable media of claim 11, wherein configuring at least a subset of the set of alarm rule suggestions comprises:
causing the set of alarm rule suggestions to be displayed to a user; and
in response to the user accepting the set of alarm rule suggestions, configuring the set of alarm rule suggestions as alarm rules in the monitoring system of the cloud platform.

18. The one or more non-transitory computer-readable media of claim 11, wherein configuring at least a subset of the set of alarm rule suggestions comprises:
causing the set of alarm rule suggestions to be displayed to a user in a user interface, wherein the user interface provides, for each alarm rule suggestion, a user-selectable control for selecting the corresponding alarm rule suggestion; and
in response to the user selecting a particular alarm rule suggestion using the corresponding user-selectable control, configuring the particular alarm rule suggestion as an alarm rule in the monitoring system of the cloud platform.

19. The one or more non-transitory computer-readable media of claim 11, wherein:
the rule-based explainability model comprises a coverage-based explainability model, and
using the rule-based explainability model comprises for each signal:
identifying a combination of a threshold and a comparison condition that results in a highest increase of coverage of the one or more anomalies;
generating an alarm rule based on the identified combination of the threshold and the comparison condition; and
adding the generated alarm rule to the set of alarm rule suggestions.

20. The one or more non-transitory computer-readable media of claim 19, wherein using the rule-based explainability model comprises returning the set of alarm rule suggestions in response to a coverage threshold being reached.
